(19) United States
(12) Patent Application Publication
(10) Pub. No.: US 2010/0149800 A1
(43) Pub. Date: Jun. 17, 2010

(54) LIGHT SOURCE MODULE

(75) Inventor: SHAN-FU HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/502,386

(22) Filed: Jul. 14, 2009

(30) Foreign Application Priority Data
Dec. 12, 2008 (CN) 200810306206.1

(51) Int. Cl. F21V 13/04

(52) U.S. Cl. 362/235; 362/308

(57) ABSTRACT

An exemplary light source module includes a base, a plurality of light sources, a reflecting member, and a collimating lens. The base has a recess formed therein. The light sources are mounted on a sidewall of the recess. The reflecting member is positioned in the recess, and has a reflecting surface facing the light sources. The collimating lens is positioned on the reflecting member, and includes a light incident surface facing the light sources and the reflecting surface, and a light output surface. The collimating lens is configured for collimating incident light beams and outputting parallel light from the light output surface.

### BACKGROUND

1. Technical Field

The present invention relates to light source modules, and particularly, to a light source module including a plurality of light sources.

2. Description of Related Art

A plurality of light sources, such as light emitting diodes, are frequently used together to form a light source module. Such light source module can be used as street lamp, indoor lamp, etc.

In a single light source, a light intensity of an area nearer to a central region of the light source is greater than that of an area nearer to a peripheral region of the light source. As such, even if the plurality of light sources are arrayed in the light source module, a uniform light intensity of the entire light source module is hard to be achieved.

What is needed, therefore, is a light source module, which can overcome the above shortcoming.

### BRIEF DESCRIPTION OF THE DRAWINGS

Many aspects of the light source module can be better understood with reference to the following drawings. The components in the drawings are not necessarily drawn to scale, the emphasis instead being placed upon clearly illustrating the principles of the present light source module. Moreover, in the drawings, like reference numerals designate corresponding parts throughout the several views.

FIG. 1 is a schematic, isometric view of a light source module in accordance with a first embodiment.

FIG. 2 is a cross-sectional view of the light source module shown in FIG. 1, taken along the line II-II.

FIG. 3 is a schematic, isometric view of a light source module in accordance with a second embodiment.

### DETAILED DESCRIPTION OF THE EMBODIMENTS

Embodiments of the present light source module will now be described in detail below and with reference to the drawings.

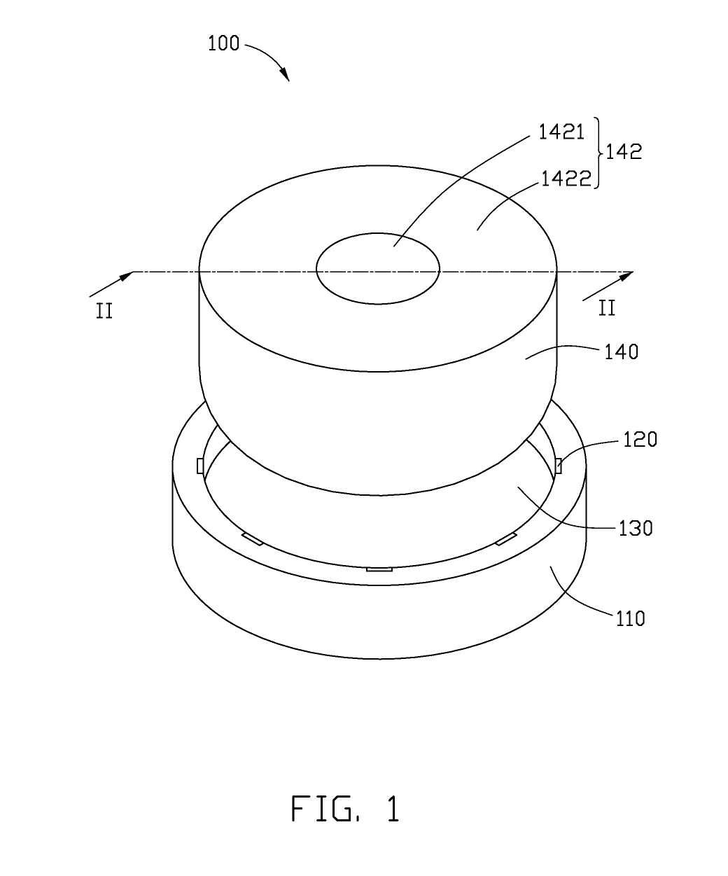

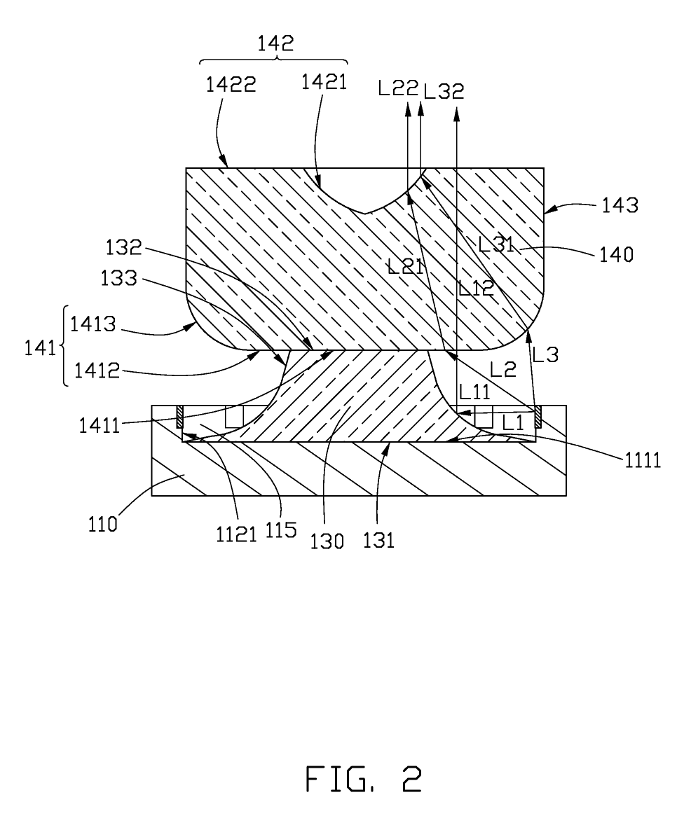

Referring to FIGS. 1 and 2, an exemplary light source module 100 in accordance with a first embodiment, is provided. The light source module 100 includes a base 110, a plurality of light sources 120, a reflecting member 130, and a collimating lens 140.

The base 110 is metallic, and is circular shaped. The base 110 has a circular recess 115 formed at a top thereof. The light sources 120 may be light emitting diodes. The light sources 120 are mounted on a sidewall 1121 of the recess 115, and are evenly spaced from each other. Preferably, a reflecting film is coated on the sidewall 1121 between the light sources 120.

The reflecting member 130 is positioned in the recess 115. The reflecting member 130 is substantially shaped as frustum, and has a bottom surface 131, a top surface 132, and a reflecting surface 133 defined on the entire side surface between the bottom surface 131 and the top surface 132. The bottom surface 131 is in contact with the bottom 1111 of the recess 115. A diameter of the bottom surface 131 is substantially equal to that of the bottom 111, and is greater than that of the top surface 132. A height of the reflecting member 130 is greater than the depth of the recess 115. The reflecting surface 133 is substantially paraboloid-shaped, and faces towards the light sources 120.

The collimating lens 140 is positioned on the top surface 132 of the reflecting member 130, with a flat bottom 1411 thereof in contact with the top surface 132. The collimating lens 140 includes a light incident surface 141 neighboring the flat bottom 1411 and facing towards the light sources 120 and the reflecting surface 133, and a light output surface 142 defined on overall top surface thereof. The light incident surface 141 includes a flat portion 1412 nearest to the flat bottom 1411, and a convex portion 1413. The convex portion 1413 is a chamfering between the flat portion 1412 and a side surface 143 of the collimating lens 140. The convex portion 1413 is capable of converging incident light beams. The light output surface 142 includes a circular flat portion 1422 and a concave portion 1421. The concave portion 1421 is located at a central region of the flat portion 1422, and is capable of diverging converged light beams.

In use, referring again to FIG. 2, when the light sources 120 are on, the light sources 120 emits light beams. Part of the light beams, such as light L2 and L3 each would trans-through the light incident surface 141 directly with an incident angle (not shown), and part of the light beams, such as light L1 would be reflected into light L11. In the anterior case, the light L21 and L31 in the collimating lens 140, which are traceable from the incident light L2 and L3, change their light path and form parallel light L22 and L32 perpendicular to the flat portion 1422 at the light output surface 142. That is, the incident light L2 and L3 are collimated. In the posterior case, the light L11 would trans-through the light incident surface 141 at the flat portion 1412. As the light L11 is perpendicularly trans-through the flat portion 1412, the light L12 in the collimating lens 140, which is traceable from the incident light L11 would not change its light path at the light output surface 142.

Due to the circular recess 115, the reflecting member 130 and the collimating lens 140, a uniform output light can be obtained.

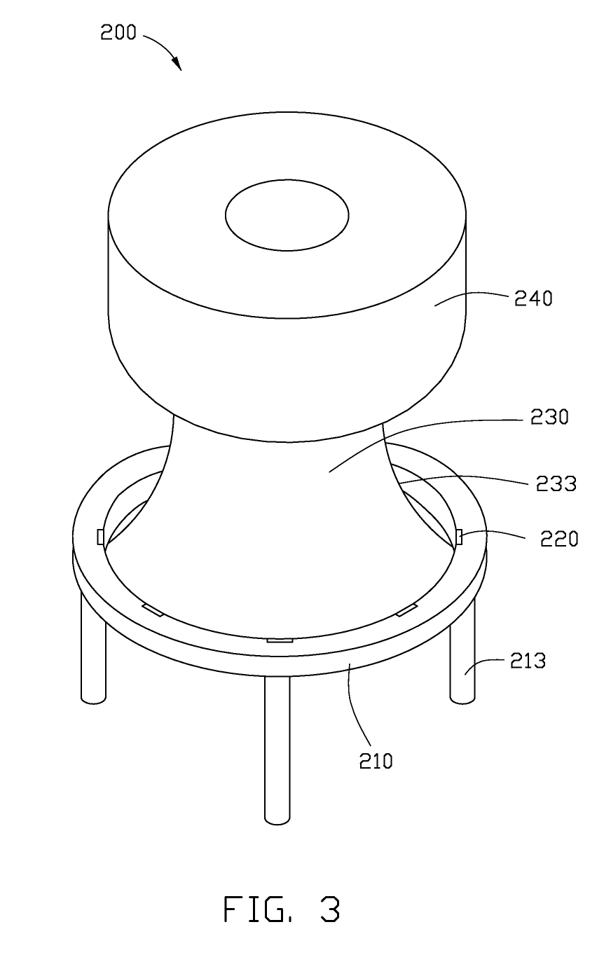

Referring to FIG. 3, an exemplary light source module 200 in accordance with a second embodiment, is provided. The light sources 220, the reflecting member 130, the reflecting surface 233, and the collimating lens 240 are essentially similar to those in the light source module 100 illustrated above, however, a plurality of legs 213 are formed on a bottom of the base 210 and are configured for supporting the base 210. In this way, a better heat dissipation can be achieved.

It is understood that the above-described embodiments are intended to illustrate rather than limit the invention. Variations may be made to the embodiments without departing from the spirit of the invention. Accordingly, it is appropriate that the appended claims be construed broadly and in a manner consistent with the scope of the invention.

What is claim is:

1. A light source module, comprising:
a base having a recess formed therein;
a plurality of light sources mounted on a sidewall of the recess;
a reflecting member positioned in the recess, the reflecting member having a reflecting surface facing the light sources; and
a collimating lens positioned on the reflecting member, the collimating lens comprising a light incident surface facing the light sources and the reflecting surface, and a light output surface, the collimating lens configured for collimating incident light beams and outputting parallel light from the light output surface.

2. The light source module of claim 1, wherein the recess is circular, the light sources are evenly spaced from each other, the reflecting member is substantially shaped as a frustum, and the entire side surface of the reflecting member is the reflecting surface.

3. The light source module of claim 2, wherein the reflecting member has a bottom surface and a top surface, the bottom surface is in contact with the bottom of the recess, the collimating lens is positioned on the top surface, a diameter of the bottom surface is substantially equal to that of the bottom of the recess and is greater than that of the top surface, a height of the reflecting member is greater than a depth of the recess.

4. The light source module of claim 2, wherein the reflecting surface is substantially paraboloid-shaped.

5. The light source module of claim 1, wherein the light incident surface comprises a first flat portion and a convex portion, and the light output surface comprises a second flat portion and a concave portion, the convex portion capable of converging the incident light beams, the concave portion, the concave portion capable of diverging converged light beams.

6. The light source module of claim 5, wherein the first flat portion is on a bottom surface of the collimating lens, the convex portion is a chamfering between the first flat portion and a side surface of the collimating lens, the second flat portion is on a top surface of the collimating lens, and the concave portion is formed in the top surface at a central region of the second flat portion.

7. The light source module of claim 1, further comprising a plurality of legs formed on a bottom of the base and configured for supporting the base.

8. The light source module of claim 1, further comprising a reflecting film formed on the sidewall of the recess between the light sources.

9. A light source module, comprising:
a base having a recess formed therein;
a plurality of light sources mounted on a sidewall of the recess, and configured for emitting light beams;
a reflecting member positioned in the recess, the reflecting member having a reflecting surface facing the light sources; and
a collimating lens positioned on the reflecting member, the collimating lens comprising a light incident surface at a bottom thereof, and a light output surface at a top thereof, the light incident surface facing the light sources and the reflecting member, wherein part of the light beams emitted from the light sources is passable through the light incident surface, and is collimated into parallel light at the light output surface, and part of the light beams emitted from the light sources is reflected to the light incident surface by the reflecting member and is collimated into parallel light at the light output surface.
